(19) United States
(12) Patent Application Publication
(10) Pub. No.: US 2026/0077985 A1
(43) Pub. Date: Mar. 19, 2026

(54) DYNAMICALLY STABLE ERGONOMIC CONTROL FOR MAN-UP LIFT TRUCK

(71) Applicant: Hyster-Yale Materials Handling, Inc., Fairview, OR (US)

(72) Inventors: Tanner Reese Dendy, Greenville, NC (US); Matthew Kenneth Hoffman, Greenville, NC (US); Justin Bryant Lancaster, Pikeville, NC (US)

(73) Assignee: Hyster-Yale Materials Handling, Inc., Fairview, OR (US)

(21) Appl. No.: 18/884,498

(22) Filed: Sep. 13, 2024

(51) Int. Cl. B66F 9/075

(52) U.S. Cl. CPC B66F 9/0759; B66F 9/07568; G05G 9/047; G05G 2009/04774

(57) ABSTRACT

An operator control device for a man-up lift truck includes a handle pivotably arranged on a support structure at a pivot point. The support structure is secured to the lift truck such that horizontal and vertical positions of the pivot point are substantially fixed with respect to the lift truck during operation. The handle comprises an upper surface contoured to ergonomically support an operator's hand with an operator's wrist arranged substantially directly above the pivot point. The handle may be biased in a neutral position. Clockwise and counter-clockwise rotation of the handle may cause forward driving and stopping/reverse driving of the man-up lift truck, respectively. A thumb-operated switch can be arranged on the handle to control lift operations of the man-up lift truck. The operator control device provides dynamic stability to an operator and reduces carpal tunnel stresses and the like in the operator's wrist.

### TECHNICAL FIELD

This disclosure relates generally to operator controls for materials-handling vehicles. More specifically, this disclosure relates to speed (or throttle) and lift controls for a man-up lift truck, also referred to as a high-level order selector or order picker.

### BACKGROUND INFORMATION

Conventional man-up lift trucks have been unable to provide consistent-feeling dynamic stability for an operator (also referred to as a “user”) while providing convenient access to both speed and lift controls. It would be desirable for a man-up lift truck to have operator controls that permit one-handed operation of the speed and lift controls while providing consistent-feeling dynamic stability to the operator when moving forward, stopping, and reversing.

### SUMMARY OF DISCLOSURE

According to an embodiment, an operator control device for a man-up lift truck comprises a handle pivotably arranged on a support structure so as to pivot about a pivot point, wherein said support structure is configured to be secured to the lift truck such that a horizontal and a vertical position of the pivot point is substantially fixed with respect to the lift truck during operation of the lift truck. The handle comprises an upper surface contoured to comfortably and ergonomically support a user's hand with a user's wrist arranged substantially directly above the pivot point.

According to an embodiment, the handle of the operator control device is configured to pivot clockwise about the pivot point in response to the straightening of a user's wrist to initiate a forward operation of the lift truck to drive the lift truck in a forward direction.

According to an embodiment, a user's wrist can be maintained in a neutral position to operate the lift truck in the forward direction.

According to an embodiment, one or more control buttons are arranged on the operator control device to be operated by a finger or thumb of the user's hand while the user's hand rests on the upper surface of the handle.

According to an embodiment, an operator control device further comprises a thumb switch configured to be operated by the user's thumb to operate a lift function of the man-up lift truck, wherein pushing on an upper portion of the thumb switch raises the lift and wherein pushing on a lower portion of the thumb switch lowers the lift. The thumb switch can be operated to control the lift while the operator control device is being used to drive the lift truck in a forward or reverse direction.

According to an embodiment, the handle of the operator control device is biased in a neutral position.

According to an embodiment, the handle of the operator control device can be rotated counterclockwise about the pivot point to initiate a plugging and reverse operation of the lift truck.

According to an embodiment, the handle is configured to pivot up to approximately about 15 degrees in a clockwise direction and up to approximately about 15 degrees in a counter-clockwise direction about the pivot point. The speed of a forward operation and a reverse operation of the lift truck are varied based on an amount by which the handle is rotated about the pivot point.

According to an embodiment, bracing forces to stabilize the operator during movement of the lift truck are directed through the pivot point without imparting a rotational force to the handle. The bracing forces can further be directed through an arm and large muscle groups of the operator.

According to an embodiment, a method of controlling throttle operations of a man-up lift truck using a one-handed operator control device comprises rotating a handle of the operator control device about a pivot point that is fixed in relation to the lift truck. The lift truck is driven forward in response to clockwise rotation of the handle and the lift truck is plugged or reversed in response to counter-clockwise rotation of the handle.

According to an embodiment, the handle supports a user's wrist substantially directly above the pivot point.

According to an embodiment, the handle provides dynamic stability to a user by permitting the user to use the handle to provide a bracing force during forward, stopping, and reversing operations of the lift truck. The bracing force can travel through the pivot point of the operator control device, and can do so without rotating the operator control device. The bracing force can also travel through the arm and large muscle groups (such as a shoulder) of the operator.

According to an embodiment, the lift operations of the man-up lift truck are also controlled using the one-handed operator control device.

According to an embodiment, a man-up lift truck comprises a platform arranged on a lift. An operator control device is arranged in a control panel and configured to control the throttle and lift operations of the man-up lift truck. The operator control device comprises a handle arranged on a support in a manner that permits the handle to rotate about a pivot point, wherein the support is rigidly affixed to the man-up lift truck in a manner that maintains the pivot point in a fixed horizontal position with respect to the lift truck during operation of the man-up lift truck. Rotating the handle in a clockwise direction drives the man-up lift truck in a forward direction and rotating the handle in a counter-clockwise direction inhibits forward movement and stops the man-up lift truck and drives the man-up lift truck in a reverse direction.

According to an embodiment, the handle comprises an upper surface configured to ergonomically support a user's hand with a user's wrist arranged substantially directly above the pivot point.

According to an embodiment, the handle provides dynamic stability to a user by permitting the user to use the handle to provide a bracing force during forward, plugging, and reverse operations of the man-up lift truck, wherein the bracing force is configured to be activated by a large muscle group of the user.

According to an embodiment, the operator control device comprises a thumb switch configured to be actuated by a user's thumb to raise and lower the lift.

According to an embodiment, the handle is configured to support the user's wrist in a neutral position while operating the lift truck in the forward direction to reduce carpal tunnel causing stresses on a user.

Additional aspects and advantages will be apparent from the following detailed description of example embodiments, which proceeds with reference to the accompanying drawings.

### BRIEF DESCRIPTION OF THE DRAWINGS

The foregoing and additional objects, features, and advantages of the present inventive concepts will become more readily apparent from the following detailed description of preferred embodiments, depicted in the attached drawings, in which:

FIG. 1A is an isometric illustration of a man-up lift truck being operated at ground level.

FIG. 1B is an isometric illustration of a man-up lift truck being used to pick items from a rack at a high level.

FIG. 2 is an isometric illustration of operator control devices for controlling direction, speed, and lift of a man-up lift truck according to principles of the present inventive concepts.

FIG. 3A is a front-right isometric illustration of an operator control device for controlling speed and lift of a man-up lift truck according to one embodiment.

FIG. 3B is a rear-left isometric illustration of the operator control device of FIG. 3A.

FIG. 3C is a right side view illustrating various operational positions of the operator control device of FIG. 3A.

FIG. 4 is a left isometric illustration showing a positioning of an operator's hand on the operator control device of FIG. 3A.

FIG. 5 is a left front isometric illustration further showing a positioning of an operator's fingers on a lower portion of the operator control device of FIG. 3A.

FIGS. 6A-6C are right isometric illustrations showing a user positioning the operator control device of FIG. 3A in various operating positions.

FIG. 7 is a right isometric illustration showing a movement angle of an operator's wrist between the forward and reverse operating positions of the operator control device of FIG. 3A.

FIGS. 8A and 8B illustrate bracing forces operating on a user during a stopping or reverse operation of a lift truck.

FIGS. 9A and 9B illustrate bracing forces operating on a user during a forward operation of a lift truck.

FIG. 10 is a schematic illustration of a man-up lift truck operator.

FIG. 11 is a somewhat schematic illustration showing the location of the operator control device of FIG. 3A within a man-up lift truck according to one embodiment.

FIG. 12 is a right side view illustrating the location of a pivot point in relation to a user's hand in the operator control device of FIG. 3A arranged in a neutral position according to one embodiment.

FIG. 13 is a right side view further illustrating the location of the pivot point in relation to a user's hand in the operator control device of FIG. 3A arranged in a forward position.

FIG. 14 is a right top isometric illustration showing the location of thumb and finger controls in relation to a user's hand in the operator control device of FIG. 12.

FIG. 15 is a left-rear isometric view of an operator control device for controlling speed and lift of a man-up lift truck, according to one embodiment.

FIG. 16 is a right-front isometric view of the operator control device of FIG. 15.

FIG. 17 is a top view of the operator control device of FIG. 15.

FIG. 18 is a right side view of the operator control device of FIG. 15.

FIG. 19 is a left side view of the operator control device of FIG. 15.

FIG. 20 is a rear side view of the operator control device of FIG. 15.

FIG. 21 is a front side view of the operator control device of FIG. 15.

### DETAILED DESCRIPTION OF EMBODIMENTS

### Preliminary Notes

Example embodiments are described below with reference to the accompanying drawings. Unless otherwise expressly stated, the sizes, positions, etc., of components, features, elements, etc., as well as any distances therebetween, are not necessarily to scale, and may be disproportionate and/or exaggerated for clarity.

The embodiments described herein are merely examples, set forth by way of illustration only and not limitation. Those skilled in the art will recognize in light of the teachings herein that there are alternatives, variations and equivalents to the example embodiments described herein and their component parts. For example, other embodiments are readily possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprise,” “comprises,” “comprising,” “include,” “includes,” “including,” “has,” “have,” and “having,” when used in this document, are open-ended and specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another and not to imply any relative order, placement, or ranking. For example, one element could be termed a “first element” and similarly, another element could be termed a “second element,” or vice versa. The same is true of labels like (a), (b), (c) or (1), (2), (3), etc. The section headings used herein are for organizational purposes only and are not to be construed as limiting the subject matter described.

Unless indicated otherwise, the terms “about,” “thereabout,” “substantially,” etc. mean that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “right,” left,” “below,” “beneath,” “lower,” “above,” and “upper,” and the like, may be used herein for ease of description to describe one element's or feature's relationship to another element or feature, as illustrated in the drawings. It should be recognized that the spatially relative terms are intended to encompass different orientations in addition to the orientation depicted in the drawings. For example, if an object in the figures is turned over, elements described as “below” or “beneath” other elements or features would then be oriented “above” the other elements or features. Thus, the term “below” can, for example, encompass both an orientation of above and below. An object may be otherwise oriented (e.g., rotated 90 degrees or at other orientations) and the spatially relative descriptors used herein may be interpreted accordingly.

Unless clearly indicated otherwise, all functional or operative connections may be direct or indirect. Similarly, unless clearly indicated otherwise, all physical connections may be rigid or non-rigid, permanent or temporary, direct or indirect (e.g., via intermediary components).

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings. Additionally, the drawings may include non-essential elements that are included only for the sake of thoroughness. These non-essential elements may be removed entirely or left only in outline form if drawing changes are desired to create greater clarity.

Not every feature shown in every drawing is labeled with a reference number, even though the same feature may be labeled with a reference number on other drawings. Reference numbers have been omitted where it is believed they would unnecessarily clutter a drawing. However, all rights are reserved to add reference numbers to the drawings to clarify aspects of the embodiments. Moreover, some views omit some features shown in other views. Finally, the drawings sometimes illustrate variations from one drawing to another, even where those drawings are intended to depict the same embodiment.

### Overview

Man-up lift trucks (or order selectors or pickers) permit a truck operator to move around a warehouse or similar facility and move vertically up and down to pick items from shelving units or racks. Because the operator may need to operate the lift truck from a significant height, both actual and perceived stability during truck operation are desirable.

According to principles described herein, an operator control device is provided which enhances dynamic stability during operation of a man-up lift truck. According to one embodiment, the operator control device provides one-handed control of truck speed and braking control along with up and down movement of the lift.

According to one embodiment, an operator control device provides wrist-activated throttle control of speed and braking along with thumb-activated control of the hydraulic lift. The operator control device comprises an ergonomically shaped handle configured to comfortably fit the hand contours of the average user's (e.g., 95th percentile) right (or left) hand. The handle is pivotably mounted on a support stem that is attached to the lift truck at a desired height. The desired height can be selected so as to be most comfortable for an average user. A biasing member, such as a spring or other biasing mechanism orients the handle in a neutral position. The pivot point can be arranged through a stability vector of the operator to provide dynamic stability during movement of the truck. The design can further optimize use of large muscle groups for the repetitive motions to reduce operator stress and to enhance comfort. And the design can be configured such that the bracing force does not impart a rotational force to the handle.

In operation, as a user straightens his or her wrist, the handle is rotated in a clockwise direction around the pivot point to initiate a forward movement of the lift truck. To stop the lift truck, the operator bends the control hand upwards (cupping the wrist) to rotate the handle counter-clockwise around the pivot point. Continued holding of the handle in the rotated upwards position after stopping can operate the lift truck in reverse.

According to one embodiment, a thumb control is arranged on the handle so as to be proximal to a user's thumb. The thumb control can be a switch, button, or combination of controls that permit operation of the lift using the operator's thumb or other finger. In one embodiment, the thumb control is a rocker switch biased in a neutral position proximal to a user's thumb. Pushing the upper or top portion of the switch causes the lift to move upwards. Pushing the lower or bottom portion of the switch causes the lift to move downwards. Releasing the switch causes the lift to maintain its current height. By arranging the lift control switch in proximity to a user's thumb (or other finger), the up and down movement of the platform can be controlled at the same time the truck is being operated in a forward or reverse direction and using the same hand.

According to an embodiment, an operator control device for a man-up lift truck can include a handle pivotably arranged on a support structure so as to pivot about a pivot point, wherein said support structure is configured to be secured to the man-up lift truck such that a horizontal and a vertical position of the pivot point is substantially fixed with respect to the lift truck during operation of the man-up lift truck. The handle can include an upper surface contoured to ergonomically support a hand of an operator with an operator's wrist arranged substantially directly above the pivot point. The handle can further provide dynamic stability to the operator by permitting the operator to use the handle to provide a bracing force during forward, plugging, and reverse operations of the man-up lift truck. The bracing force can be directed through an axis of the pivot point. The bracing force can also be directed through an arm and large muscle groups (such as shoulder muscles) of the operator. The handle can further be designed such that the bracing force does not impart a rotational force to the handle.

### Example Embodiments Illustrated in the Drawings

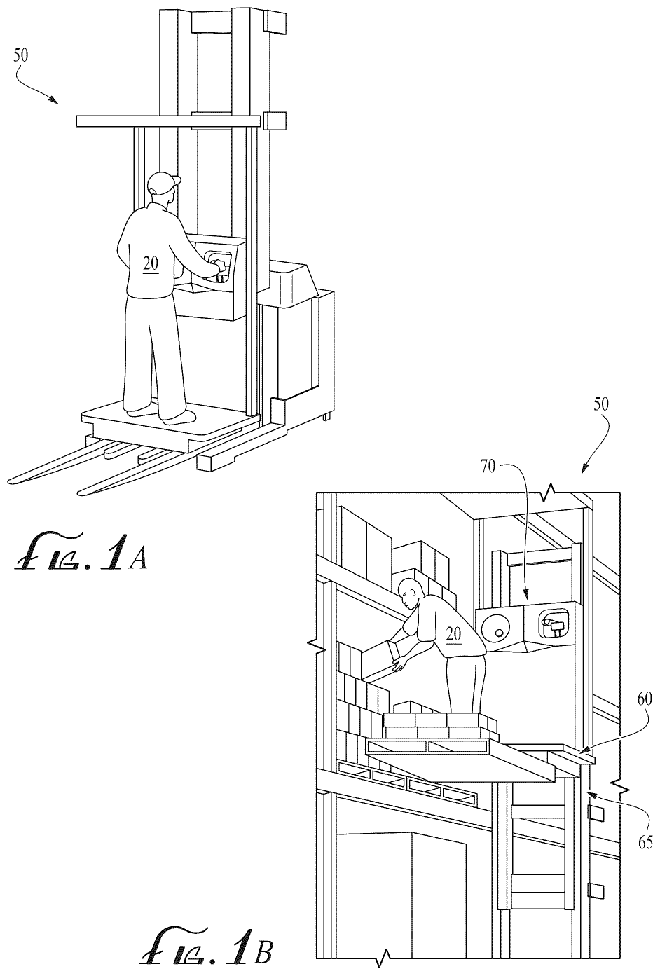

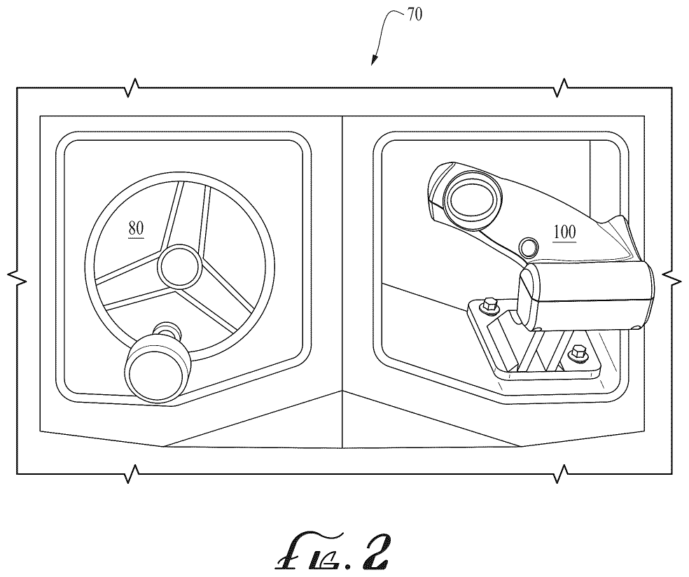

FIGS. 1A and 1B illustrate a man-up lift truck 50 being operated by an operator 20 to select and pick items from a warehouse rack. Referring to FIGS. 1A and 1B, a man-up lift truck 50 can be maneuvered around a warehouse to select and pick items from various levels of a rack or to place items on the racks. As used herein, the term “pick” in its various forms should also be understood to mean “place.” Referring specifically to FIG. 1B, a platform 60 can be arranged on a lift 65 of the lift truck 50 so as to raise and lower an operator 20 to a level of the desired item for picking. The lift 65 may be hydraulically powered, electrically powered, or powered by other means. The lift truck 50 can be driven with the platform 60 raised. However, it is desirable that controls 70 be included that provide dynamic stability (meaning that the operator has at least three points of contact with the lift truck 50 to maintain the operator's stability) during operation of the lift truck 50, particularly when the platform 60 is elevated.

FIG. 2 illustrates operator control devices 80 and 100, respectively, arranged in an operator control panel 70 of the lift truck 50 for controlling direction as well as speed and lift height of the man-up lift truck 50 according to one embodiment. Referring to FIG. 2, a turning wheel 80 can be provided on the left (or right) of the operator panel 70 to control a direction of travel of the lift truck 50. An operator control device 100 can be provided on the right (or left) of the operator panel 70 to control the forward speed, reverse speed, and plugging of the lift truck 50 as well as a height of the lift 65 and the operator platform 60.

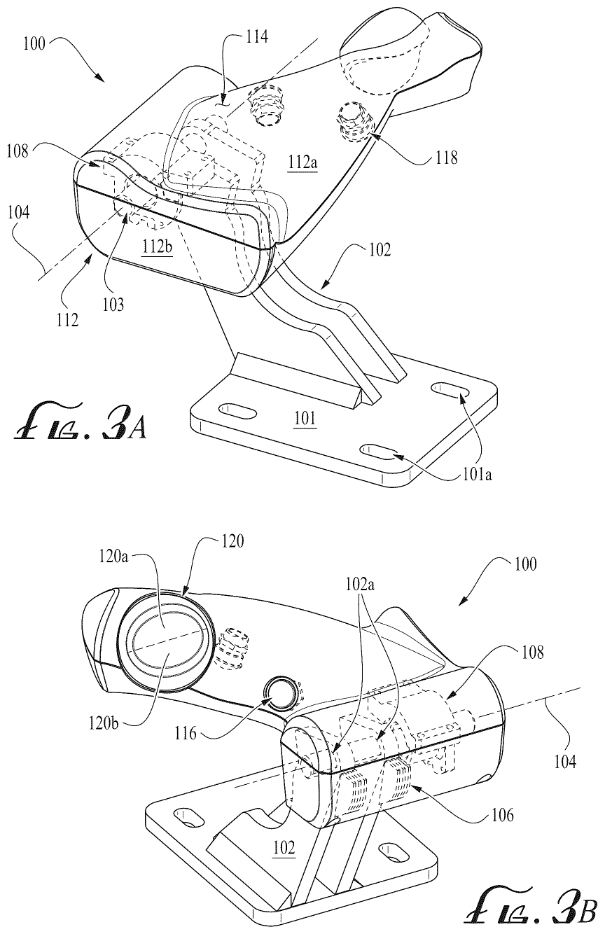

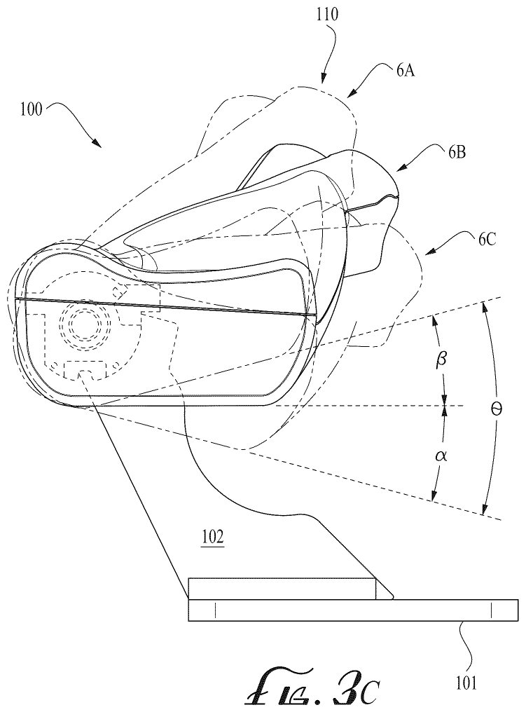

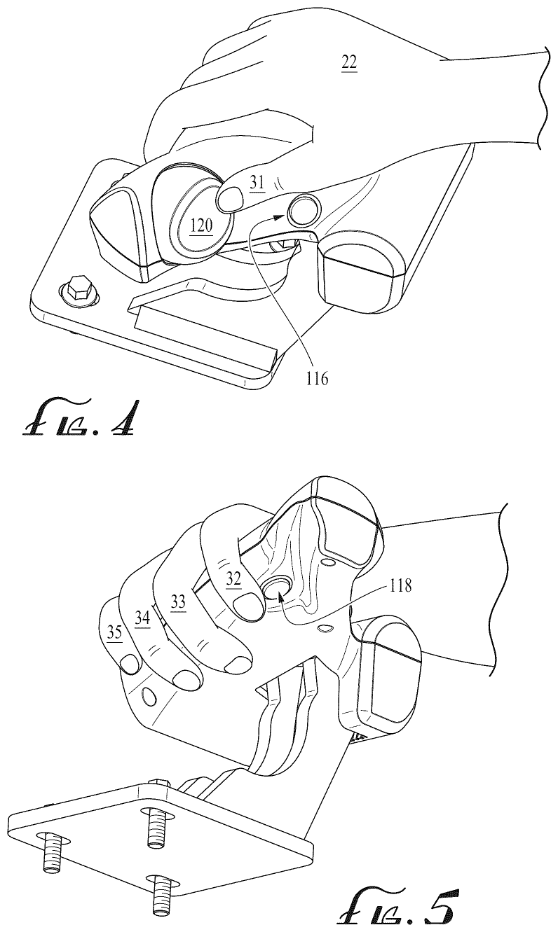

FIGS. 3A-14 illustrate the construction and operation of an operator control device 100 of a man-up lift truck 50 according to one embodiment. Referring initially to FIGS. 3A-3C, an operator control device 100 comprises an ergonomically configured handle 110 pivotably mounted on a support stem 102 extending from a base plate 101. The base plate 101 can be connected to a frame or other mounting surface of the lift truck 50, for instance using bolts secured through one or more base holes 101a. The handle 110 is configured to pivot forward (clockwise) and backward (counter-clockwise) up to a desired angle α, β, respectively, around a pivot point (axis) 104. The desired angle α, β, can, for instance, be approximately about 15 degrees in each direction (clockwise α and counter-clockwise β) and approximately about 30 degrees maximum pivot θ around the pivot point 104. A rod 103 extending through holes 102a in the support stem 102 can provide a hinge mechanism that permits the handle 110 to pivot about the pivot point 104.

The handle 110 is preferably biased in a neutral position 6B (FIG. 3C) by a biasing mechanism 106 such as a torsion or rotational spring. A potentiometer (or other position detecting device) 108 can be arranged in the handle 110 to detect a degree of pivot about the pivot point 104 and to produce a corresponding signal. Signals from the position detecting device can be sent to a control center of the lift truck 50, such as a vehicle system manager or other suitable controller, to control the operation of the lift truck 50. Forward (clockwise) rotation of the hand can move the handle 110 into a forward position 6C (FIG. 3C), and rearward (counter-clockwise) rotation of the hand can move the handle 110 into a reverse/plugging position 6A (FIG. 3C).

The handle 110 can comprise a housing 112 formed from an upper and a lower shell 112a, 112b, respectively. The upper and lower shells 112a, 112b can be connected together using threaded screws, snap-fit connection members, press-fit connection members, adhesive, or any other desired mechanical and/or chemical connection. The housing 112 can contain the internal components, circuitry, sensors, switches, buttons, and wiring for performing the handle 110 functions.

The upper shell 112a preferably comprises an ergonomically-shaped upper surface 114 contoured to comfortably support a user's hand 22 (see FIGS. 4-6C). Buttons 116, 118, such as an auxiliary button 116 and a horn button 118 can be arranged along the housing 112 in proximity to a user's fingers 32, 33, 34, 35 or thumb 31 to permit easy one-handed operation of the horn and auxiliary functions during operation of the lift truck 50. The auxiliary button 116 can, for instance, be arranged proximal to a user's thumb 31 while the horn button 118 may be arranged proximal to a user's index finger 32. Additional or alternative buttons (not shown) may be provided along the housing 112 in proximity to the user's fingers 31-35 to activate different functions. Although the illustrated embodiment shows a user's right hand, a left-handed model is, of course, possible and within the scope of the present inventive concepts.

A rocker switch 120 can be arranged on the handle 112 in proximity to a user's thumb 31 to operate hydraulics or other mechanisms to raise and to lower the lift truck platform 60 during operation of the lift truck 50. The rocker switch 120 can be biased in a neutral position that maintains the current height of the platform 60. Pressing one portion (e.g., an upper portion) 120a of the switch 120 can raise the platform 60, and pressing another portion (e.g., a lower portion) 120b of the switch 120 can lower the platform 60. By arranging the rocker switch 120 on the handle 110 in proximity to a user's thumb 31 (or other finger), the raising and lowering functions can be performed simultaneously with the forward or rearward driving operations of the lift truck 50 using only one hand 22. Moreover, the horn button 118 can also be pressed simultaneously with forward/rearward driving operations.

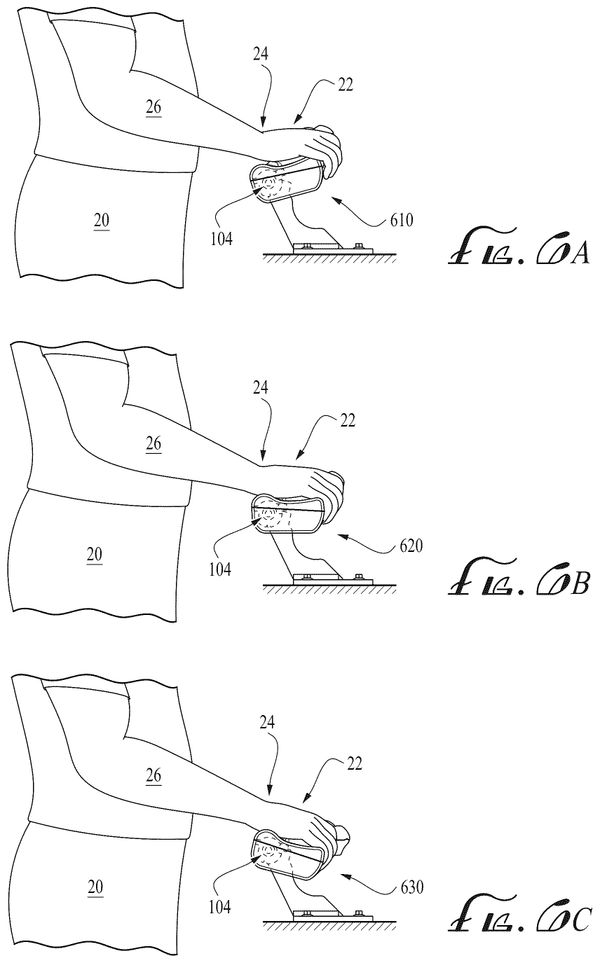

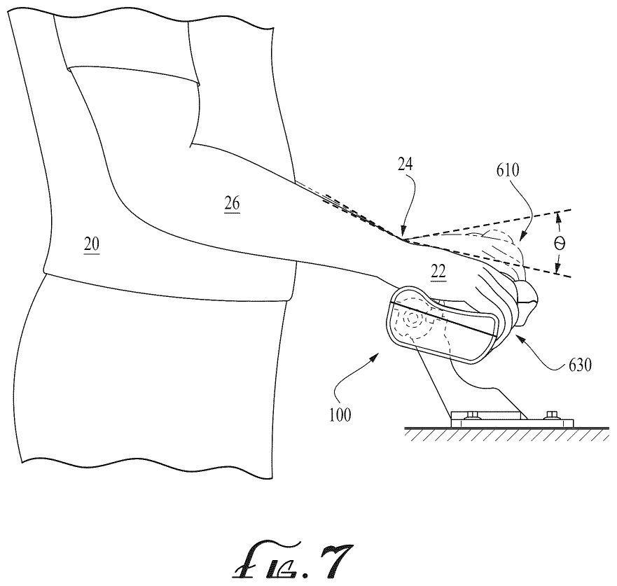

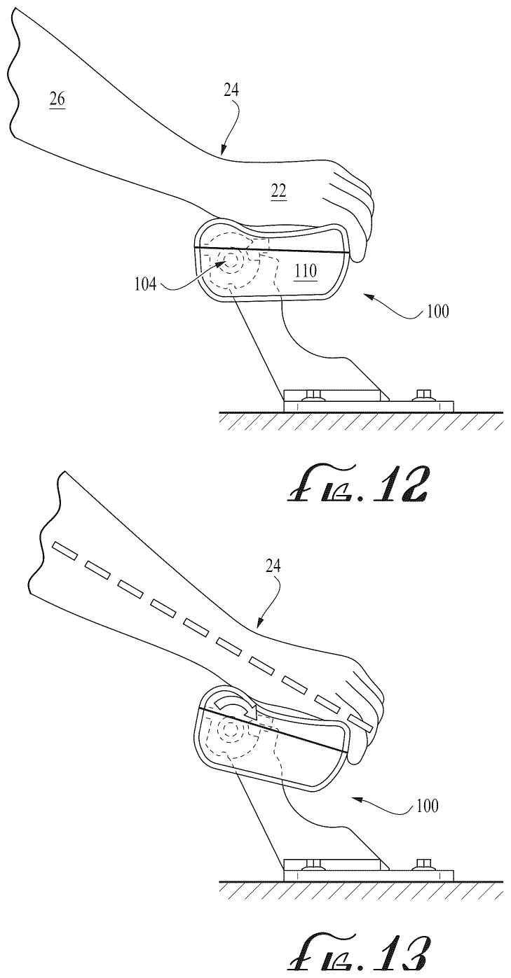

FIGS. 6A-6C are isometric illustrations showing a user 20 positioning the operator control device 100 of FIGS. 3A-3C in various operating positions. Referring now additionally to FIGS. 6A-6C, the pivot point 104 can be arranged so as to be substantially directly below a user's wrist 24 when the user 20 places his/her hand 22 on the handle 110. As discussed in further detail below, the pivot point 104 is preferably located such that bracing forces are vectored through the hand 22 and/or arm 26 of the user 20 substantially orthogonally to the axis of rotation of the pivot point 104 to provide dynamic stability while throttling (accelerating, braking, and reversing). The pivot point 104 allows for dynamic motion and proper ergonomics while providing a consistent-feeling, that is, substantially non-moving, point of contact with the truck 50 for stability to the operator 20. The height H (see FIGS. 10-11) of the handle 110 is preferably selected so as to maintain the user's arm 26 at a comfortable resting angle Ω. The height H may, for example, be approximately 965 mm from a floor of the platform 60.

In operation, bending of the hand 22 downward to straighten the user's wrist 24 rotates the handle 110 clockwise (from the vantage as shown in FIGS. 6A-7) about the pivot point 104 and positions the handle 110 in a forward operating position 630 which activates a forward operation of the lift truck 50. The speed of forward movement can be controlled by the amount (angle α—FIG. 3C) by which the handle 110 is rotated about the pivot point 104. The greater the angle a of rotation, the greater the speed. Relaxing the wrist 24 permits the biasing mechanism 106 to move the handle 110 back to a neutral position 620 in which a desired neutral position operation is performed. For example, the drive command may be stopped permitting the lift truck 50 to gradually regen to a stop as parameterized by the truck settings, the lift truck 50 may be permitted to coast, or the current operation of the lift truck 50 may be maintained. Cupping the wrist 24 pivots the handle 110 counterclockwise around the pivot point 104 to a reverse position 610 which drives a plugging or stopping operation to stop (if the lift truck 50 is traveling in a forward direction) and then reverse operation of the lift truck 50. The greater the angle β of rotation, the greater the stopping (plugging) force and then reversing speed. Relaxing the wrist 24 permits the biasing member 106 to move the handle 110 back to the neutral position 620. Likewise, if the lift truck 50 is traveling in a reverse direction, rotating the handle 110 to a forward drive position 610 drives a plugging or stopping operation and then forward operation of the lift truck 50.

FIG. 7 is a side view of an operator 20 using the operator control device 100 and illustrating the wrist movement between a forward operating position 630 and a stopping or reversing operating position 610. Referring additionally to FIG. 7, to go from a fully forward operating position 630 to a fully reversed operating position 610, the operator's wrist 24 need only bend by an angle θ. In one embodiment, the angle θ may be approximately 30 degrees or less. Furthermore, in a fully forward operating position 630, the wrist is kept straight (neutral). By minimizing the wrist flex needed to operate the operator control device 100 and maintaining a neutral wrist position for forward truck movement, wrist stresses such as those that cause carpal tunnel syndrome can be reduced, perhaps significantly.

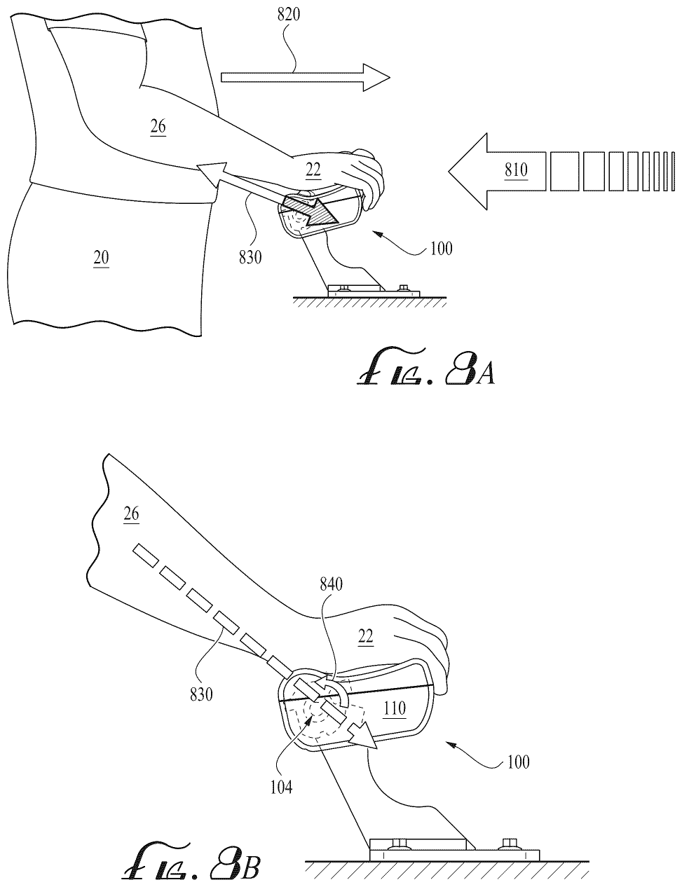

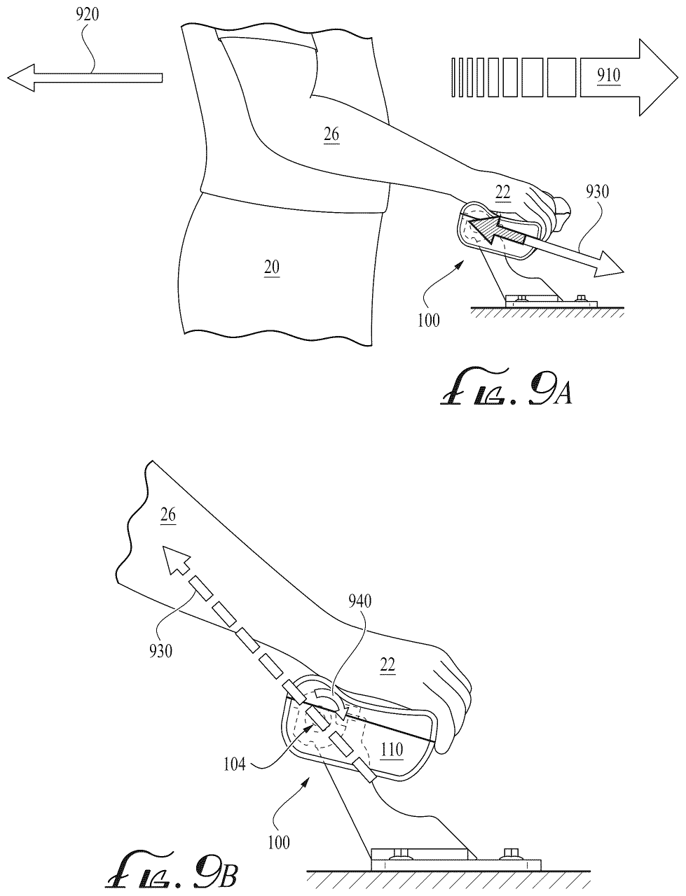

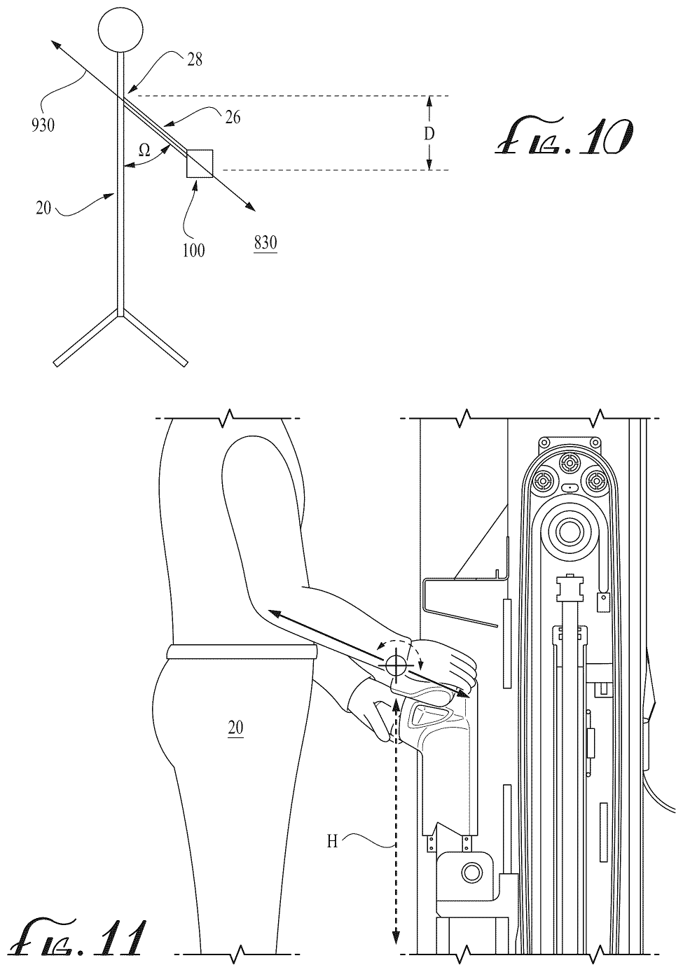

FIGS. 8A and 8B illustrate various forces operating on a user 20 during a stopping (plugging) or reverse operation of the lift truck 50, while FIGS. 9A and 9B illustrate various forces operating on a user 20 during a forward operation of the lift truck 50. Referring now additionally to FIGS. 8A-9B, the dynamic stability provided by the principles taught herein will be described in further detail.

As illustrated in FIGS. 8A and 8B, for instance, during a stopping or reversing operation, as the truck 50 slows or reverses, an operator's body reaction (represented by arrow 820) is to move forward in opposition to the stopping motion (truck deceleration, represented by arrow 810) of the vehicle 50. According to principles of the present inventive concepts, however, the operator control device 100 is designed and arranged to provide dynamic stability to the operator 20 during these operations. The location of the operator control device 100 is fixed such that it does not move forward or rearward or upward or downwards in relation to the truck 50. The operator control device 100 thereby provides a brace for resisting the stopping force 810 using the operator's large shoulder muscle group. Specifically, as the vehicle 50 slows and reverses, the operator 20 can push against the operator control device 100 with his or her hand 22 (in some examples, primarily through the palm of the hand 22) to provide a bracing force (represented by arrow 830) in opposition to the stopping force 810. As illustrated in FIG. 8B, as the handle 110 is rotated counterclockwise (represented by arrow 840) around the pivot point 104 to perform the stopping/reversing operation, the push force and bracing force 830 are directed substantially orthogonally through the pivot point 104 of the horizontally and vertically fixed handle 110 to stabilize the truck operator 20. This bracing force 830 does not cause the operator's body weight to exert a rotational force on the operator control device 100 that would cause an unintended operation (e.g., acceleration, deceleration, raising, lowering).

Similarly, as illustrated in FIGS. 9A and 9B, when the wrist 24 is straightened, the handle 110 is rotated clockwise (represented by arrow 940) around the pivot point 104 and the truck 50 is driven forward. The truck acceleration (represented by arrow 910) causes an operator's body reaction (represented by arrow 920) in the opposite direction. The operator's instinct is to pull on the handle 110 of the operator control device 100 to steady himself or herself. The hand pull creates a bracing force (represented by arrow 930) that steadies the operator 20. The pull force and bracing force 930 is directed substantially orthogonally through the pivot point 104 of the horizontally and vertically fixed handle 110 to stabilize the truck operator 20 during the dynamic truck movements, for example, by not imparting a rotational force on the handle 110.

FIG. 10 is a schematic illustration of an operator 20 using the operator control device 100 according to principles described herein. Referring to FIG. 10, the operator control device 100 can be arranged so that the operator's arm 26 can be maintained at a desirable arm angle Ω and at a desired vertical distance D between shoulder and hand. The push 830 and pull forces 930 can be directed through the operator's shoulder 28 muscles so that large muscle groups can do a majority of the work of stabilizing the operator 20 to reduce strain on the operator 20 during truck 50 operation.

FIG. 11 is a somewhat schematic illustration showing the location of the operator control device 100 within a man-up lift truck 50 according to one embodiment. Referring to FIG. 11, the operator control device 100 can be arranged at a predetermined height H from the platform 60 so as to provide the desired arm angle Ω for the average user. The height H could also be made adjustable to more comfortably accommodate operators 20 of various heights.

FIGS. 12-14 provide various illustrations summarizing various benefits of the embodiments described herein. FIG. 12 is a side view illustrating the location of a pivot point 104 in relation to a user's hand 22 and wrist 24 with the operator control device 100 arranged in a neutral position. As shown in FIG. 12, the operator control device 100 is designed and arranged such that a pivot point 104 for rotation of the handle 110 is arranged substantially directly below the user's wrist 24. The location of the operator control device is fixed so that its horizontal and vertical position remains substantially constant during operation of the truck 50. This arrangement permits operation of the operator control device 10 with minimal operator hand movement, reduces stress on the operator 20, and provides dynamic stability by allowing the operator 20 to steady himself or herself using the control device 100 without rotating the handle 110.

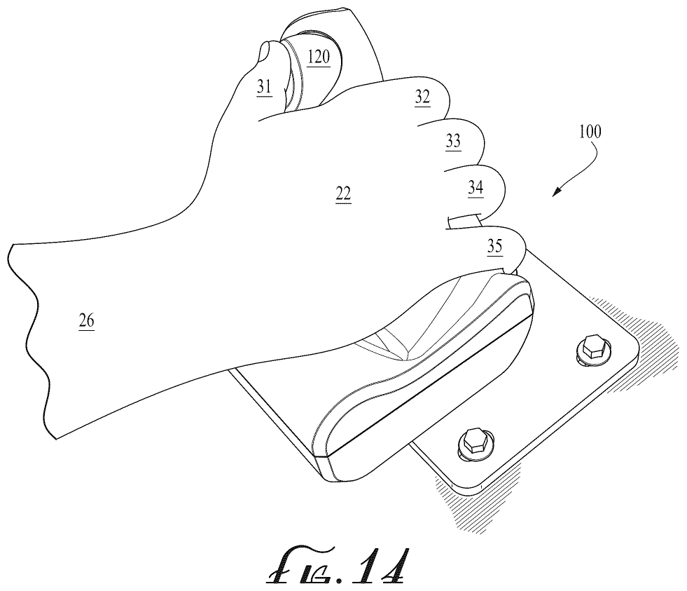

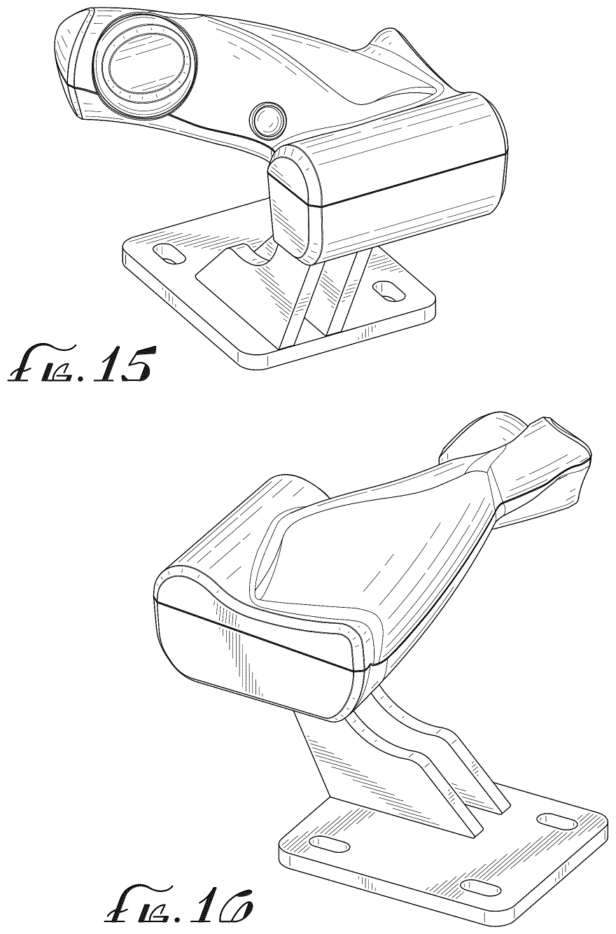

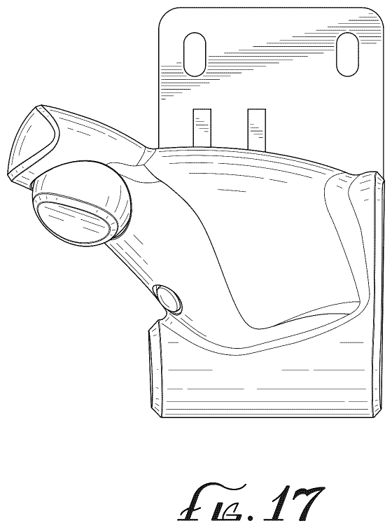

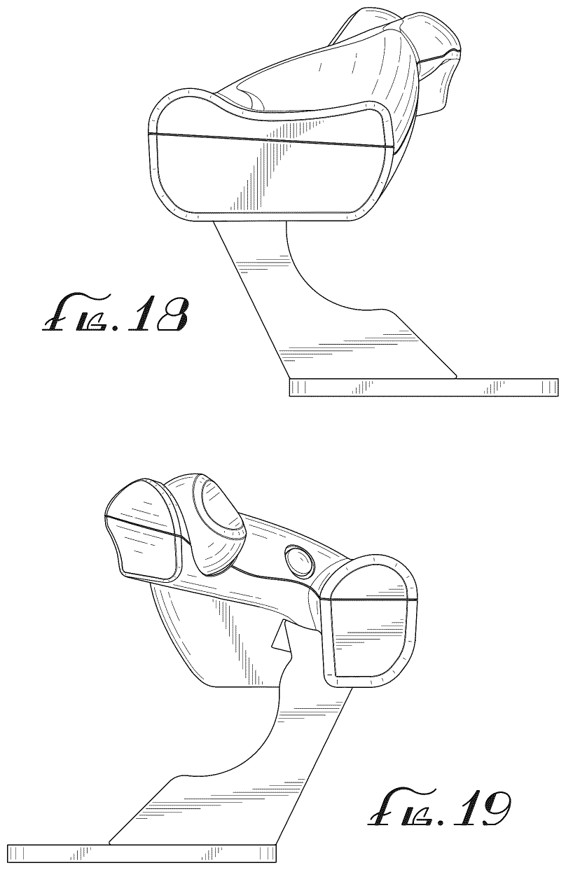

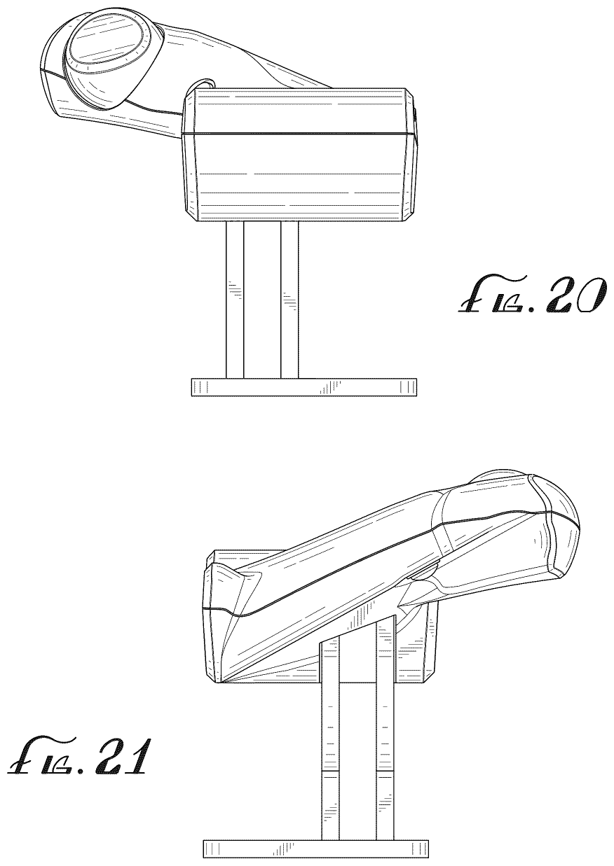

FIG. 13 is a side view further illustrating the location of the pivot point 104 in relation to a user's hand 22 and wrist 24 in relation to the operator control device 100 arranged in a forward position. As shown in FIG. 13, the truck 50 can be operated in a forward direction while the operator 20 maintains a neutral wrist position. This inhibits carpal tunnel issues and related or similar issues by reducing stress on the user's wrist 24. Furthermore, the fixed device 100 position permits a pull force to be directed through the pivot point 104 to a user's large shoulder muscles for stabilization. By utilizing the larger muscle groups, stress on the user 20 can be further reduced.

FIG. 14 is an isometric illustration of the operator control device 100 indicating the location of thumb and finger controls 120, 116, 118 in relation to a user's hand 22 according to one embodiment. As shown in FIG. 14, an operator 20 can simultaneously operate the throttle by rotating the handle 110 as described above and lift functions and horn functions of the man-up lift truck 50 using a single hand 22. For example, lift and lower functions can be operated by the thumb 31 operating control 120. As a further example, the thumb 31 may be used to activate an auxiliary button 116 located underneath the thumb pad in FIG. 14 to control an auxiliary function such as turning lights on or off, or other suitable auxiliary function. And, finger 32 may be used to activate a horn button 118 located on the handle 110 underneath the finger 32 while the operator 20 is driving the lift truck 50. The operator control device 100 may provide convenient access to the lift functions, horn, and auxiliary control with a single hand 22 all while operating a throttle of the truck 50 to drive forward, stop, and reverse the truck 50. Other and/or additional control functions may be included and may be operated by the thumb 31, finger 32 or other suitable finger.

### Conclusion

The terms and descriptions used above are set forth by way of illustration and example only and are not meant as limitations. Those skilled in the art will recognize that many variations, enhancements, and modifications of the concepts described herein are possible without departing from the underlying principles of the invention. For example, skilled persons will appreciate that the subject matter of any sentence or paragraph can be combined with subject matter of some or all of the other sentences or paragraphs, except where such combinations are mutually exclusive. The scope of the invention should therefore be determined only by the following claims, claims presented in continuation or reissue patent applications, and equivalents to the foregoing claims.

1. An operator control device for a man-up lift truck, said operator control device comprising:
a handle pivotably arranged on a support structure so as to pivot about a pivot point, wherein said support structure is configured to be secured to the lift truck such that a horizontal and a vertical position of the pivot point is substantially fixed with respect to the lift truck during operation of the lift truck; and
the handle comprising an upper surface contoured to comfortably support a hand of an operator with an operator's wrist arranged substantially directly above the pivot point.

2. An operator control device according to claim 1, wherein the handle is configured to pivot clockwise about the pivot point in response to straightening of the operator's wrist to initiate a forward operation of the lift truck to drive the lift truck in a forward direction.

3. An operator control device according to claim 2, wherein the operator's wrist can be maintained in a neutral position to operate the lift truck in the forward direction.

4. An operator control device according to claim 1, further comprising one or more control buttons arranged to be operated by a finger or thumb of the operator's hand while the operator's hand rests on the upper surface of the handle.

5. An operator control device according to claim 4, further comprising:
a thumb switch configured to be operated by the operator's thumb to operate a lift function of the man-up lift truck, wherein pushing on an upper portion of the thumb switch raises the lift and wherein pushing on a lower portion of the thumb switch lowers the lift.

6. An operator control device according to claim 5, wherein the thumb switch can be operated to control the lift function while the operator control device is being used to drive the lift truck in a forward or reverse direction.

7. An operator control device according to claim 1, wherein the handle is biased in a neutral position.

8. An operator control device according to claim 1, wherein the handle can be rotated counterclockwise about the pivot point to initiate a plugging and reverse operation of the lift truck.

9. An operator control device according to claim 1, wherein the handle is configured to pivot up to approximately about 15 degrees in a clockwise direction and up to approximately about 15 degrees in a counter-clockwise direction about the pivot point.

10. An operator control device according to claim 9, wherein a speed of a forward operation and a reverse operation of the lift truck are varied based on an amount by which the handle is rotated about the pivot point.

11. An operator control device according to claim 1, wherein bracing forces to stabilize the operator during movement of the lift truck are directed through the pivot point without imparting a rotational force to the handle.

12. An operator control device according to claim 11, wherein the bracing forces are further directed through an arm and large muscle groups of the operator.

13. A method of controlling throttle operations of a man-up lift truck using a one-handed operator control device, the one-handed control device comprising a handle configured to be held and operated by a hand of an operator, the method comprising:
in response to rotation of a wrist of the operator, rotating the handle of the operator control device about a pivot point that is fixed in relation to the man-up lift truck;
driving the man-up lift truck forward in response to clockwise rotation of the handle; and
plugging or reversing the man-up lift truck in response to counter-clockwise rotation of the handle.

14. A method according to claim 13, wherein the handle supports the wrist of the operator substantially directly above the pivot point.

15. A method according to claim 13, wherein the handle provides dynamic stability to the operator by permitting the operator to use the handle to provide a bracing force during forward, stopping, and reversing operations of the lift truck.

16. A method according to claim 15, wherein the bracing force travels through the pivot point of the operator control device.

17. A method according to claim 15, wherein the bracing force does not apply a rotational force to the handle.

18. A method according to claim 15, wherein the bracing force travels through an arm and large muscle group of the operator.

19. A method according to claim 13, further comprising:
controlling lift operations of the man-up lift truck using the one-handed operator control device.

20. A man-up lift truck comprising:
a platform arranged on a lift;
an operator control device arranged in a control panel and configured to control throttle and lift operations of the man-up lift truck;
the operator control device comprising a handle arranged on a support in a manner that permits the handle to rotate about a pivot point, wherein the support is rigidly affixed to the man-up lift truck in a manner that maintains the pivot point in a fixed horizontal position with respect to the lift truck during operation of the man-up lift truck; and
wherein rotating the handle in a clockwise direction drives the man-up lift truck in a forward direction, and
wherein rotating the handle in a counter-clockwise direction stops the man-up lift truck and operates the man-up lift truck in a reverse direction.

21. A man-up lift truck according to claim 20, wherein the handle comprises an upper surface configured to ergonomically support a hand of an operator with an operator's wrist arranged substantially directly above the pivot point.

22. A man-up lift truck according to claim 21, wherein the handle provides dynamic stability to the operator by permitting the operator to use the handle to provide a bracing force during forward, plugging, and reverse operations of the man-up lift truck, wherein the bracing force is configured to be activated by a large muscle group of the operator.

23. A man-up lift truck according to claim 22, wherein the bracing force does not apply a rotational force to the handle.

24. A man-up lift truck according to claim 21, wherein the operator control device comprises a thumb switch configured to be actuated by an operator's thumb to raise and lower the lift.

25. A man-up lift truck according to claim 21, wherein the handle is configured to support the operator's wrist in a neutral position while operating the lift truck in the forward direction to reduce carpal tunnel causing stresses on the operator.

26. An operator control device for a man-up lift truck, said operator control device comprising:
a handle pivotably arranged on a support structure so as to pivot about a pivot point, wherein said support structure is configured to be secured to the man-up lift truck such that a horizontal and a vertical position of the pivot point is substantially fixed with respect to the lift truck during operation of the man-up lift truck;
the handle comprising an upper surface contoured to ergonomically support a hand of an operator with an operator's wrist arranged substantially directly above the pivot point; and
wherein the handle provides dynamic stability to the operator by permitting the operator to use the handle to provide a bracing force during forward, plugging, and reverse operations of the man-up lift truck.

27. An operator control device according to claim 26, wherein the bracing force is directed through an axis of the pivot point.

28. An operator control device according to claim 26, wherein the bracing force is directed through an arm and large muscle groups of the operator.

29. An operator control device according to claim 28, wherein the large muscle groups include an operator's shoulder muscles.

30. An operator control device according to claim 26, wherein the bracing force does not impart a rotational force to the handle.
